(19) United States
(12) Patent Application Publication
(10) Pub. No.: US 2026/0133464 A1
(43) Pub. Date: May 14, 2026

(54) ENTANGLEMENT PRESERVING LOW-NOISE FREQUENCY CONVERSION OF PHOTONS ENTANGLED WITH A TRAPPED ION INTO THE TELECOMMUNICATIONS C-BAND

(71) Applicant: IonQ, Inc., College Park, MD (US)

(72) Inventors: James David SIVERNS, College Park, MD (US); John Michael HANNEGAN II, Glenn Dale, MD (US)

(21) Appl. No.: 18/943,630

(22) Filed: Nov. 11, 2024

(51) Int. Cl. G02F 1/35; G02F 1/355; G02F 1/365; G06E 3/00

(52) U.S. Cl. CPC G02F 1/3503; G02F 1/3551; G02F 1/3558; G02F 1/365; G06E 3/00; G02F 2202/20

(57) ABSTRACT

Aspects of the present disclosure relate generally to systems and methods for use in the implementation and/or operation of quantum information processing (QIP) systems, and more particularly, to photon conversion to the C-band in QIP systems.

### CLAIM OF PRIORITY

The present application claims priority to U.S. Provisional Application No. 63/598,288, filed on Nov. 13, 2023, and hereby incorporated herein by reference.

### TECHNICAL FIELD

Aspects of the present disclosure relate generally to systems and methods for use in the implementation and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

Fiber-based quantum networks require photons at telecommunications wavelengths to interconnect qubits separated by long distances. Trapped ions are leading candidates for quantum networking with high-fidelity two-qubit gates, long coherence times, and the ability to readily emit photons entangled with the ion's internal qubit states. However, trapped ions typically emit photons at wavelengths incompatible with telecommunications fiber.

Photons emitted from trapped barium ions emit photons in the visible spectrum. These photon wavelengths have high losses in both optical fibers and in on-chip photonic-integrated circuit (PIC) technologies such as switches/filters etc.

It is therefore important to develop new techniques that improve the design, fabrication, implementation, and/or control of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of methods and systems for photon wavelength conversion in a quantum computing system.

In an aspect, a quantum computing system is provided. The quantum computing system includes a first photonic-wavelength conversion stage that, in turn, includes: a first stage laser loop configured to perform a first wavelength conversion of a photon emitted from an ion qubit; and a first stage Sagnac-type loop configured to preserve an entanglement between the ion qubit and the photon during the first wavelength conversion using a polarization matching process. The quantum computing system further includes a second photonic-wavelength conversion stage that, in turn, includes: a second stage laser loop configured to perform a second wavelength conversion of the photon; and a second stage Sagnac-type loop configured to preserve an entanglement between the ion qubit and the photon during the second wavelength conversion using the polarization matching process.

In another aspect, a method for converting a photon wavelength is provided. The method includes configuring a first stage laser loop in a first photonic-wavelength conversion stage to perform a first wavelength conversion of a photon emitted from an ion qubit. The method further includes configuring a first stage Sagnac-type loop in the first photonic-wavelength conversion stage to preserve an entanglement between the ion qubit and the photon during the first wavelength conversion using a polarization matching process. The method also includes configuring a second stage laser loop in a second photonic-wavelength conversion stage to perform a second wavelength conversion of the photon. The method additionally includes configuring the second stage Sagnac-type loop in the second photonic-wavelength conversion stage to preserve an entanglement between the ion qubit and the photon during the second wavelength conversion using the polarization matching process.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates a view of atomic ions in a linear crystal or chain, in accordance with exemplary aspects of the disclosure.

FIG. 2 illustrates an example of a quantum information processing (QIP) system, in accordance with exemplary aspects of the disclosure.

FIG. 3 illustrates an example of a computer device, in accordance with exemplary aspects of the disclosure.

FIG. 4 illustrates an example photonic-wavelength conversion system/process, in accordance with exemplary aspects of the present disclosure.

FIG. 5 illustrates a further example of the photonic-wavelength conversion system/process of FIG. 4, in accordance with exemplary aspects of the present disclosure.

FIGS. 6-7 illustrate an example method for wavelength conversion of a photon from a non-C-band to the telecom C-band, in accordance with exemplary aspects of the present disclosure.

### DETAILED DESCRIPTION

Aspects of the present disclosure are directed to entanglement preserving low-noise frequency conversion of photons entangled with a trapped ion into telecommunications C-band. In telecommunications, C-band (C for “conventional”) refers to the wavelength range 1530-1565 nm, which corresponds to the amplification range of erbium doped fiber amplifiers (EDFAs). EDFAs enable high-gain optical amplification with low noise, and have enabled long-distance optical transmission without using an O-E (optical-to-electronic) and E-O converter. After a long period of exploration and testing, it has been determined that light with a wavelength of 1260nm˜1625 nm has the smallest dispersion signal distortion with low loss, which is the most suitable for transmission in optical fiber.

For the sake of illustration, aspects of the present disclosure are described with respect to trapped barium ions. However, it is to be appreciated that the teachings of the present disclosure can apply to other trapped ions besides trapped barium ions.

In an aspect, the wavelengths of photons emitted from trapped barium ions are converted into the telecommunications C-band to integrate the photons into on-chip photonic-integrated circuit (PIC) technologies such as, for example, switches, filters, and so forth. Such integration can be achieved without experiencing large transmission losses which are reduced by several orders of magnitude over prior art approaches. The lower transmission losses also make it possible to transmit the photons over a large distance using optical fibers.

In an aspect, two stages of wavelength conversion are performed on a 493 nm barium photon to provide an 825 nm barium photon as an output of the first stage and a 1554 nm barium photon as an output of the second stage.

In an aspect, pump lasers having wavelengths of 1228 nm and 1762 nm are used in the first stage and the second stage, respectively. The pump laser wavelengths are compatible with barium ion trap systems. Moreover, the wavelengths of the pump lasers are far enough away from the target conversion wavelengths of 825 nm and 1554 nm, respectively to avoid issues such as pump-induced noise corrupting the converted signal photon signal such as in previous photon wavelength conversion schemes.

Each of two wavelength conversion stages use a Sagnac-like configuration. In this way, the entanglement between the ion qubit and the photon is preserved through both stages of conversion unlike in previous photon wavelength conversion schemes.

The Sagnac effect refers to the phenomenon where a rotation of a structure, such as a beam of light or electrons, can cause a phase shift in the interference fringes produced when the divided beams recombine. This effect is described by a mathematical equation involving the area enclosed, angular velocity, particle energy, and Planck's constant.

The Sagnac effect can be obtained from a setup called a ring interferometer or Sagnac interferometer. A beam of light is split and the two resultant beams of light are made to follow the same path but in opposite directions, e.g., in a fiber optic coil or mirror directed path. On return to the point of entry, the two light beams are allowed to exit the ring and undergo interference. The relative phases of the two exiting beams, and thus the position of the interference fringes, are shifted according to the angular velocity of the interferometer system while being spun. Hence, when the interferometer system is at rest with respect to a nonrotating frame, the light takes the same amount of time to traverse the ring in either direction. However, when the interferometer system is spun, one beam of light has a longer path to travel than the other in order to complete a pass through the mechanical frame, and so takes longer, resulting in a phase difference between the two light beams. The path used herein can be embodied as a square but can also be implemented using other shapes including triangles.

As used herein with respect to at least one illustrative aspect, the term “Sagnac-like configuration” refers to a configuration of lasers and devices (e.g., mirrors) for splitting and recombining light using rotations with respect to a ring shape (e.g., square or triangle). Aspects of the present invention use a Sagnac-like configuration having pump lasers of various frequencies. In particular, a trapped barium ion emits a 493 nm photon entangled with its internal qubit states. The 493 nm photon passes through two stages of frequency conversion in a nonlinear optical material such as a non-linear wave guide (NLWG). The first stage of conversion uses a pump laser at 1228 nm to convert the 493 nm photon to an 825 nm photon. The second stage of conversion uses a pump laser at 1762 nm to convert the 825 nm photon into the telecom C-band.

The use of lasers already compatible with barium ion trap systems provide the pumping (1228 nm and 1762 nm). These pump lasers are also far enough away from the target conversion wavelengths of 825 nm and 1554 nm to avoid issues with pump-induced noise swamping the converted single photon signal as in prior art approaches.

Further, the entanglement preserving frequency conversion operations in accordance with this disclosure can be applicable to multiple types of quantum information processing (QIP) systems and qubit technologies. While various aspects of the multi-parcel operations are described with reference to a QIP system based on trapped-atom qubits, the disclosure is not limited in that respect. Indeed, the entanglement preserving frequency conversion operations in accordance with this disclosure can be used in other types of QIP systems based on solid-state qubits. Additionally, while described with reference to qubits, the entanglement preserving frequency conversion operations of this disclosure can in some cases be implemented for other types of quantum devices, such as qudit devices.

It is to be appreciated that aspects of the present disclosure improve the functioning of a computing system such as a QC by reducing losses in optical fibers and in on-chip PIC technologies. In this way, optimum performance may be achieved by a QC due to minimization of losses in photons emitted from trapped barium ions as described various aspects of the present disclosure.

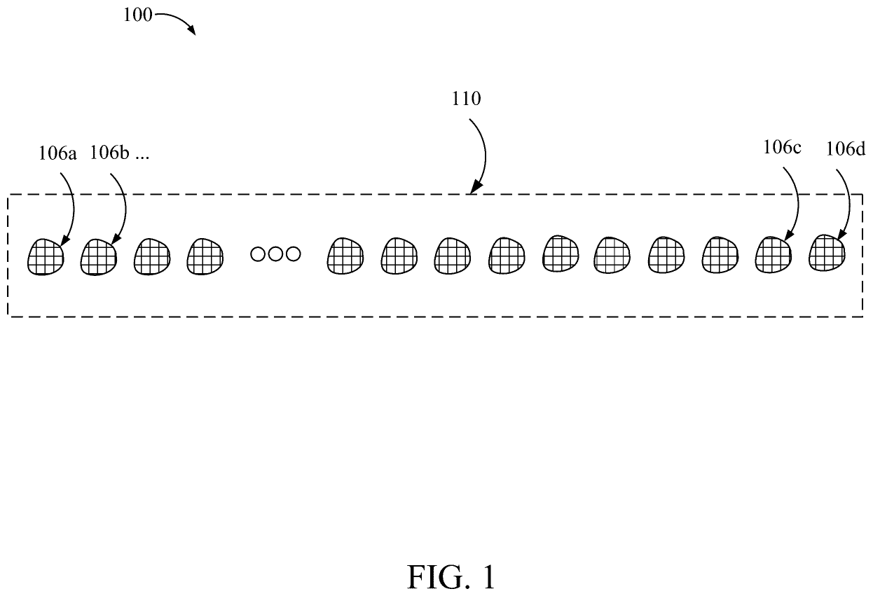

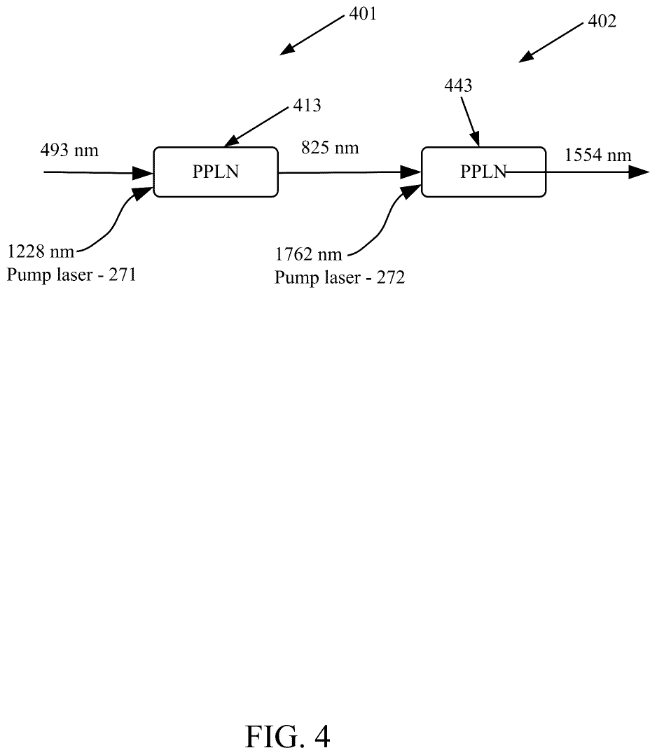

Solutions to the issues described above are explained in more detail in connection with FIGS. 1-7, with FIGS. 1-3 providing a description of QIP systems or quantum computers, and more specifically, of atomic-based QIP systems or quantum computers, with FIGS. 4-7 providing a description of the entanglement preserving frequency conversion into the telecom C-band.

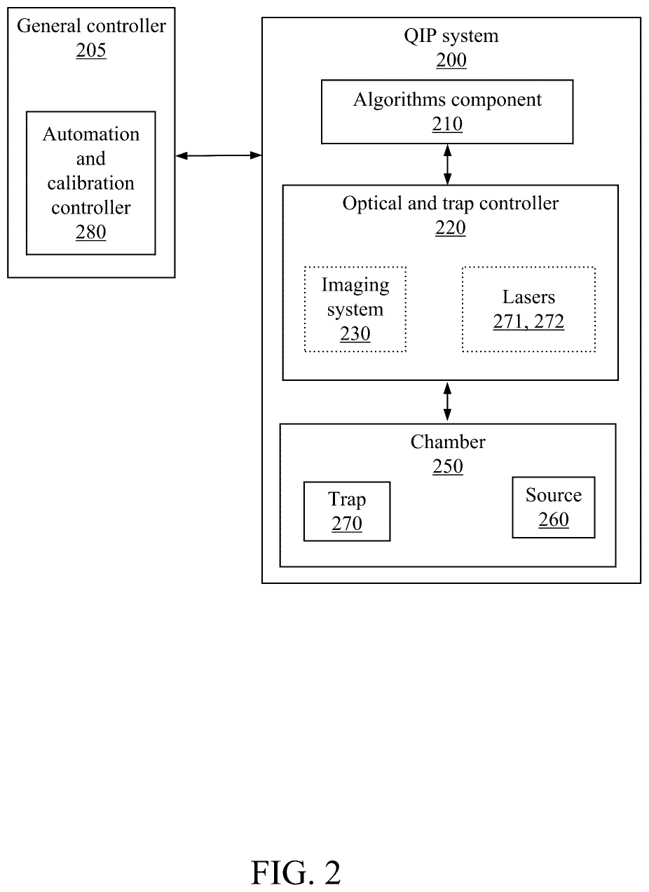

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., ¹⁷¹Yb⁺ ions), for example. The atomic ions are illuminated with laser (optical) radiation tuned to a resonance in ¹⁷¹Yb⁺ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic ytterbium ions, neutral atoms, Rydberg atoms, different atomic ions or different species of atomic ions may also be used. The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers 271, 272 and optionally other lasers, and further controls the operation of optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

In an aspect, the algorithms component 210 includes code for performing a two stage wavelength conversion process on an input photon emitted from an ion such as, but not limited to, a barium ion. The two-stage wavelength conversion process takes a non-C-band wavelength of a photon and converts it into the C-band. In an aspect, the output of the two-stage wavelength conversion process is a 1554 nm barium photon obtained from an input 493 nm barium photon. Other elements may be used given the teachings of the present disclosure provided herein.

In an aspect, the code stored in the algorithms components 210 for performing a two stage wavelength conversion process on an input photon in the trap 270 be executed by the general controller 205 and/or the optical and trap controller 220. The code stored in the algorithms components 210 may be configured to control operation of the general controller and/or the optical and trap controller 220 to convert an input photon in the trap 270 having a non-C-band wavelength into a photon having a C-band wavelength. For example, laser wavelengths, device (e.g., mirror, polarizing beam splitter (PBS), and half wave plate (HWP)) angles, and other parameters for each of the stages may be stored in the algorithms component 210.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the algorithms component 210.

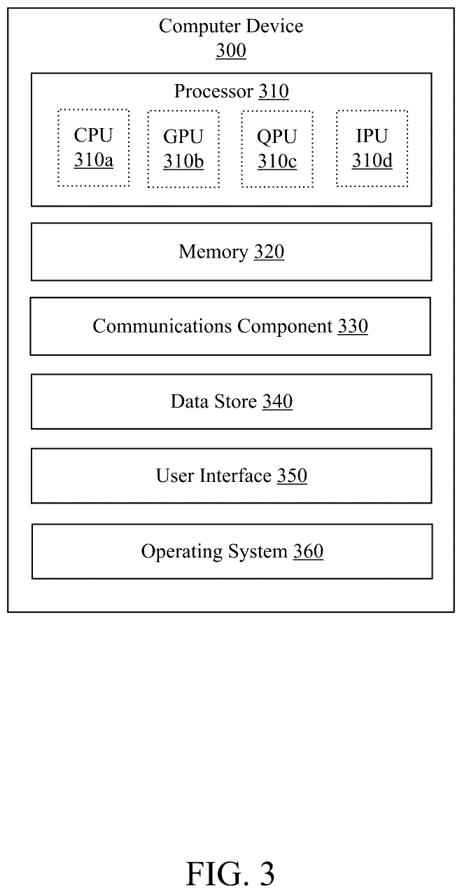

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In operation of the QIP system (e.g., QIP system 200), qubit frequency may shift due to noise, resulting in control phase mismatch between quantum gates and qubits and result in errors. Aspects of the present disclosure include systems and methods for measuring the noise outside and check for periodic noise, e.g., 60 HZ noise from the electronics or a few Hertz noise from the cryostats, and apply waveforms having the same frequency components and adjust the amplitude components and/or phase components to cancel out the noise. The underlying assumption is that noise is stable under long time scales. Thus, the noise cancelling (NC) waveforms in accordance with the present disclosure can be applied. Over time, due to shifting of the noise, as determined by the sensors 290, the NC waveforms may need to be recalibrated, as mentioned below in a recalibration step of method 500.

One or more aspects of the present disclosure perform a Ramsey experiment. A

$${T}_{2}^{¿}$$

Ramsey experiment measures the dephasing time,

$${T}_{2}^{¿} ,$$

of a qubit and the qubit's detuning, which is a measure of the difference between the qubit's resonant frequency and the frequency of the rotation pulses being used to perform the

$${T}_{2}^{¿}$$

Ramsey experiment. Applied cancellation field amplitude and phase can be optimized by measuring the dephasing time and attempting to increase it as qubit frequency fluctuations are reduced when the noise is cancelled.

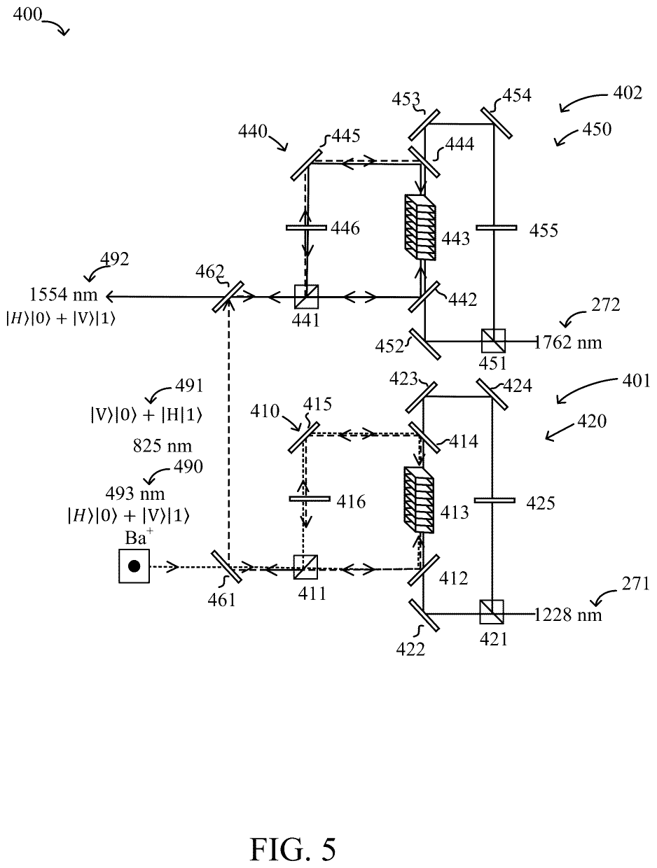

FIGS. 4-5 below describe various features of the present disclosure, in accordance with various aspects. While the present disclosure is not limited to the specific QIP system shown in FIG. 2 and may be applied to other systems configurations and types as mentioned herein, QIP system 200 will be used hereinafter in describing the various features of the present disclosure, including with respect to FIGS. 4-5.

Referring to FIG. 4, an example photonic-wavelength conversion system/process 400 is shown, in accordance with exemplary aspects of the present disclosure.

According to an exemplary aspect, parameters of various elements of the photonic-wavelength conversion system/process 400 are controlled by the general controller 205 and/or the optical and trap controller 220 responsive to computer code stored in the algorithms section 210. That is, the photonic-wavelength conversion system/process 400 can be implemented as part of the optical and trap controller 220 and/or lasers 271 and 272 in an exemplary aspect.

In particular, a trapped barium ion emits a 493 nm photon entangled with its internal qubit states. The 493 nm photon passes through two stages of frequency conversion 401, 402 in a nonlinear optical material 413, 443 such as a non-linear wave guide (NLWG). Examples of NLWGs include periodically poled lithium niobate waveguides (PPLNWs). The first stage of conversion 401 uses a pump laser 271 at 1228 nm to convert the 493 nm photon to an 825 nm photon. The second stage of conversion 402 uses a pump laser 272 at 1762 nm to convert the 825 nm photon into the telecom C-band.

The use of lasers already compatible with barium ion trap systems to provide the pumping (1228 nm and 1762 nm). These pump lasers are also far enough away from the target conversion wavelengths of 825 nm and 1554 nm to avoid issues with pump-induced noise swamping the converted single photon signal as in prior art approaches.

Both stages of conversion 401, 402 are constructed in a Sagnac-type configuration to allow the tunable conversion of two orthogonal polarizations of the photon which preserves the entanglement between the converted photon and the ion qubit states.

Referring to FIG. 5, a further example of the photonic-wavelength conversion system/process 400 of FIG. 4 is shown, in accordance with exemplary aspects of the present disclosure.

The photonic-wavelength conversion system/process 400 includes a first photonic-wavelength conversion stage 401 and a second photonic-wavelength conversion stage 402.

The first photonic-wavelength conversion stage 401 at least includes a first stage Sagnac-type loop 410 and a first stage laser loop 420. The first stage laser loop may include a 1228 nm laser or other type of compatible laser.

The second photonic-wavelength conversion stage 402 at least includes a second stage Sagnac-type loop 440 and a second stage laser loop 450. The first stage laser loop may include a 1762 nm laser or other type of compatible laser.

In an aspect, the photonic-wavelength conversion system/process 400 is implemented by optical and trap controller 220, algorithms component 210, and trap 270, and may optionally be further implemented by general controller 205. In an aspect, the executable code controlling the functioning (frequency, wavelength, etc.) of lasers, the positioning of mirrors, the positioning of polarizing beam splitters (PBSs), the positioning of half wave plates (HWPs), and other parameters of photonic-wavelength conversion system/process 400 are stored in algorithms sections 210. The code is executed by general controller 205 and/or optical and trap controller 220, e.g., responsive to the parameters.

The lasers 271 and 272 are part of the optical and trap controller 220, as shown in FIG. 2. The mirrors, PBSs, HWPs, and non-linear waveguides (NLWGs) may be part of the trap 270 and/or part of the optical and trap controller 220.

Different aspects may place different elements of FIGS. 4-5 within different elements of system 200. For example, in one aspect, mirrors, PBSs, HWPs, and NLWGs are within trap 270. In another aspect, mirrors, PBSs, HWPs, and NLWGs are within optical and trap controller 220. In yet another aspect, mirrors, PBSs, HWPs, and NLWGs are within both trap 270 and optical and trap controller 220. For example, one or more mirrors may be within optical and trap controller 220 and remaining mirrors and optionally the PBSs, HWPs, and NLWGs are within trap 270, or vice versa. Various configurations are possible given the teachings of the present disclosure provided herein.

An input to the photonic-wavelength conversion system/process 400, i.e., to the first photonic-wavelength conversion stage 401, is a 493 nm barium photon. An output of the photonic-wavelength conversion process 400, i.e., of the second photonic-wavelength conversion stage 402, is a 1554 nm barium photon. The 1554 nm barium photon is in the telecommunications C-band.

The 493 nm barium photon 490 is directed to a PBS 411 configured as an entry point to the first Sagnac-type loop 410. The first Sagnac-type loop 410 includes the PBS 411, a mirror 412, a NLWG 413, a mirror 414, a mirror 415, and a HWP 416. The PBS 411 serves as an origination (or signal splitting) point and a termination (or signal combining) point of the first Sagnac-type loop 410. The conversion from a 493 nm Barium photon to an 825 nm Barium photon is polarization dependent. The single-photon conversion efficiency is dependent on a combination of physical factors, including the nonlinear medium used, the waveguide structure, and the polarization of the input photon relative to the crystal structure of the medium and to the waveguide (depending on the type of waveguide). In cases where each possible polarization of the photon produced by the ion is entangled with an internal qubit state of the ion, it is critical for the conversion efficiency of each photon polarization to be the same to preserve the entanglement between the photon and ion. By splitting the photons based on polarization prior to entering the frequency converting waveguide, and rotating the polarization of the photon that would normally experience low conversion efficiency, both photons can instead be converted with high efficiency, preserving the entanglement between the ion and photon. Sending both photons through the same loop in opposite directions ensures that the photons traverse the same optical path length, preserving the phase of the ion-photon entanglement (up to a global phase factor which does not affect the entanglement).

The first Sagnac-type loop 410 is injected with a 1228 nm laser emitted from the first conversion stage laser loop 420. The first conversion stage laser loop 420 includes a PBS 421, a first mirror 422, the NLWG 413, a mirror 423, a mirror 424, a HWP 425, and a laser 271.

The first Sagnac-type loop 410 and the first conversion stage laser loop 420 share a common component, namely the NLWG 413. In particular, the laser is injected into the NLWG 413 along with the input 493 nm barium photon 490 to generate a first stage output 419 as an 825 nm barium photon.

The first stage output, i.e., the 825 nm barium photon, is reflected by a mirror 461 to a mirror 462 and into an PBS 441 configured as an entry point to the second wavelength converting Sagnac-type loop 440. The second wavelength converting Sagnac-type loop 440 includes the PBS 441, a mirror 442, a NLWG 443, a mirror 444, a mirror 445, and a HWP 446. The PBS 441 serves as an origination (or signal splitting) point and a termination (or signal combining) point of the first Sagnac-type loop 440. The conversion from an 825 nm barium photon to a 1554 nm barium photon is polarization dependent.

The second Sagnac-type loop 440 is injected with a 1762 nm laser emitted from the second conversion stage laser loop 450. The second conversion stage laser loop 450 includes a PBS 451, a first mirror 452, the NLWG 443, a mirror 453, a mirror 454, a HWP 455, and a laser 272.

The second Sagnac-type loop 440 and the second conversion stage laser loop 450 share a common component, namely the NLWG 443. In particular, the laser is injected into the NLWG 443 along with the 825 nm barium photon 419 to generate a second stage output 449 as a 1554 nm barium photon, i.e., a photon in the telecommunication C-band.

The output of PBS 411 of the first Sagnac-type loop 410, namely the 825 nm barium photon, is directed to the PBS 441 of the second Sagnac-type loop 440, using mirrors 461 and 462.

The NLWGs 413, 443 may be Magnesium (Mg) or equivalent doped to reduce photorefractive damage.

Both the first photonic-wavelength conversion stage 401 and the second photonic-wavelength conversion stage 402 being in Sagnac-type configurations enables preservation of the entanglement between the ion qubit and the photon through both stages 401, 402 of conversion.

According to quantum mechanics, electromagnetic waves can also be viewed as streams of particles called photons. When viewed in this way, the polarization of an electromagnetic wave is determined by a quantum mechanical property of photons called their spin. A photon has one of two possible spins. The photon can either spin in a right hand sense or a left hand sense about its direction of travel. Circularly polarized electromagnetic waves are composed of photons with only one type of spin, either right-hand or left-hand. Linearly polarized waves consist of photons that are in a superposition of right and left circularly polarized states, with equal amplitude and phases synchronized to give oscillation in a plane.

The use of Sagnac-type configurations in both the first stage Sagnac-type loop 410 and the second stage Sagnac-type loop 440 enables preservation of the entanglement between the ion qubit and the 493 nm barium photon through both stages of conversion to the 1554 nm barium photon.

Opposite orthogonal polarizations created by PBS 411 and PBS 421 are configured to go in opposing directions through the NLWG 413 to preserve the entanglement using a polarization matching process. Opposite orthogonal polarizations created by PBS 441 and PBS 451 are configured to go in opposing directions through the NLWG 443 to preserve the entanglement using the polarization matching process. The polarization matching process includes matching orthogonal polarizations of a first laser beam emitted by the first conversion stage laser 271 to orthogonal polarizations of the photon in the first non-linear waveguide, and matching orthogonal polarizations of a second laser beam emitted by the second conversion stage laser 272 to orthogonal polarizations of the photon in the second non-linear waveguide. Thus, for example, a right hand spin (polarization) of a laser beam is matched to a right hand spin (polarization) of the photon, and a left hand spin (polarization) of a laser beam is matched to a left hand spin (polarization) of the photon. This polarizing matching process is done for each polarization of the 493 nm photon with respect to each polarization of the 1228 nm laser, and for each polarization of the 825 nm photon with respect to each polarization of the 1762 nm laser. In this way, by maintaining the polarizations of the photon during the wavelength conversions, preservation of the entanglement between the 1554 nm photon and the emitting ion can be achieved.

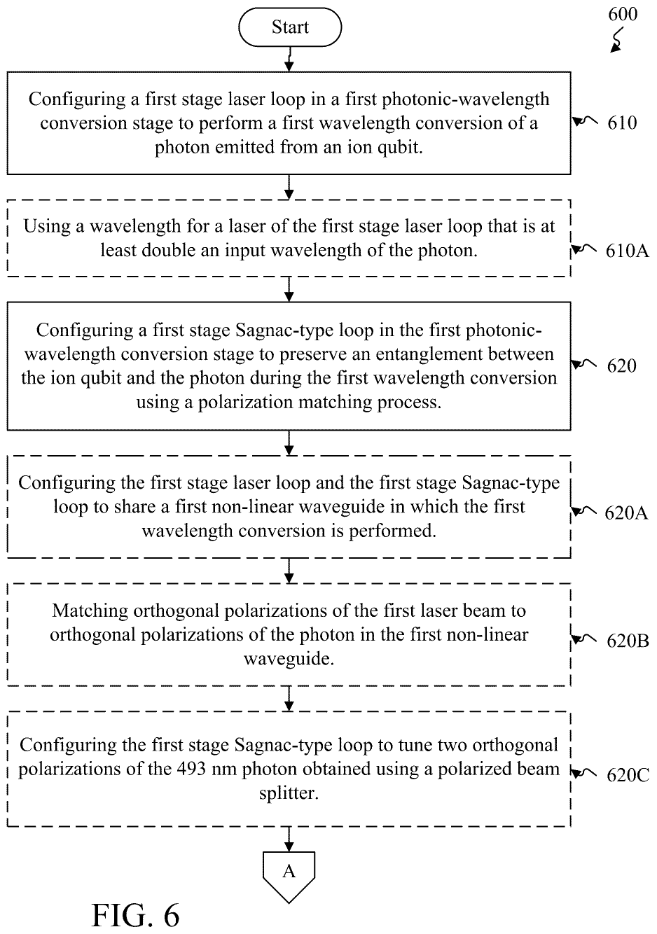

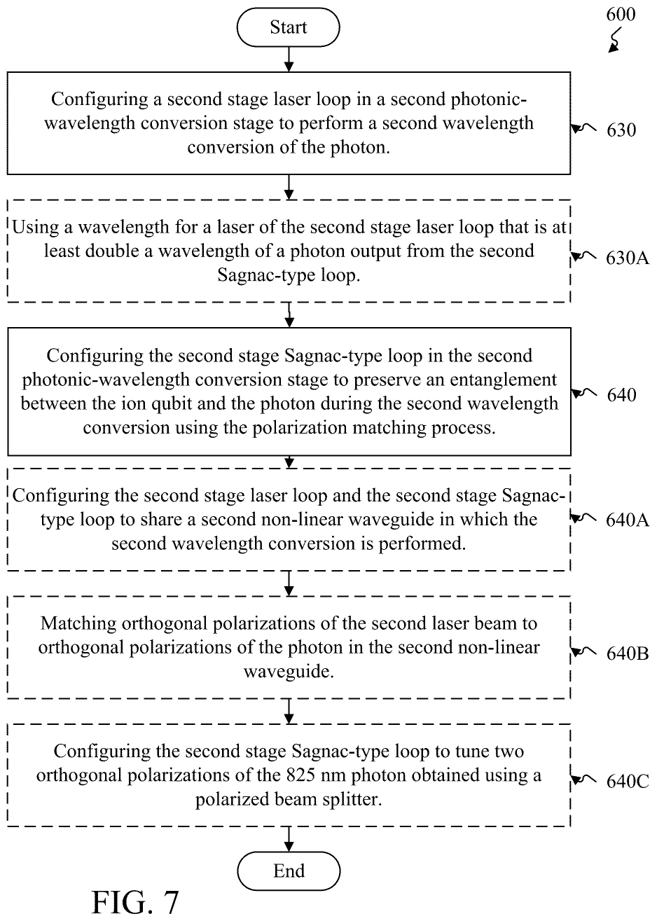

Referring now to FIGS. 6-7, an example method 600 for wavelength conversion of a photon from a non-C-band to the telecom C-band is shown and described in accordance with exemplary aspects of the present disclosure. In an aspect, the method 600 can be at least primarily performed by the general controller 205 and/or the optical and trap controller 220. In an aspect, at least one of the general controller 205 and/or the optical and trap controller 220 include and/or are otherwise connected to lasers 271 and 272. Solid lines indicate primary blocks of method 600, and dashed and/or dotted lines indicate non-primary blocks of method 600.

At block 610, the method 600 includes configuring a first stage laser loop in a first photonic-wavelength conversion stage to perform a first wavelength conversion of a photon emitted from an ion qubit. In an aspect, the photon is a 493 nm barium photon. In an aspect, the first stage laser loop includes a 1228 nm laser.

In an aspect, block 610 may include block 610A.

At block 610A, the method 600 includes using a wavelength for a laser of the first stage laser loop that is at least double an input wavelength of the photon.

At block 620, the method 600 includes configuring a first stage Sagnac-type loop in the first photonic-wavelength conversion stage to preserve an entanglement between the ion qubit and the photon during the first wavelength conversion using a polarization matching process. In an aspect, an output of the first photonic-wavelength conversion stage is taken from an output of the first stage Sagnac-type loop and includes an 825 nm photon.

In an aspect, block 620 may include one or more of blocks 620A through 620C.

At block 620A, the method 600 includes configuring the first stage laser loop and the first stage Sagnac-type loop to share a first non-linear waveguide in which the first wavelength conversion is performed.

At block 620B, the method 600 includes matching orthogonal polarizations of the first laser beam to orthogonal polarizations of the photon in the first non-linear waveguide.

At block 620C, the method 600 includes configuring the first stage Sagnac-type loop to tune two orthogonal polarizations of the 493 nm photon obtained using a polarized beam splitter.

At block 630, the method 600 includes configuring a second stage laser loop in a second photonic-wavelength conversion stage to perform a second wavelength conversion of the photon. In an aspect, the second stage laser loop includes a 1762 nm laser.

In an aspect, block 630 may include block 630A.

At block 630A, the method 600 includes using a wavelength for a laser of the second stage laser loop that is at least double a wavelength of a photon output from the second Sagnac-type loop.

At block 640, the method 600 includes configuring the second stage Sagnac-type loop in the second photonic-wavelength conversion stage to preserve an entanglement between the ion qubit and the photon during the second wavelength conversion using the polarization matching process. In an aspect, an output of the second photonic-wavelength conversion stage is taken from an output of the second stage Sagnac-type loop and includes a 1554 nm photon.

In an aspect, block 640 may include one or more of blocks 640A through and 640C.

At block 640A, the method 600 includes configuring the second stage laser loop and the second stage Sagnac-type loop to share a second non-linear waveguide in which the second wavelength conversion is performed.

At block 640B, the method 600 includes matching orthogonal polarizations of the second laser beam to orthogonal polarizations of the photon in the second non-linear waveguide.

At block 640C, the method 600 includes configuring the second stage Sagnac-type loop to tune two orthogonal polarizations of the 825 nm photon obtained using a polarized beam splitter.

Various clauses corresponding to various inventive aspects of the present disclosure are now provided.

Clause 1. A quantum computing system, comprising: a first photonic-wavelength conversion stage including: a first stage laser loop configured to perform a first wavelength conversion of a photon emitted from an ion qubit; and a first stage Sagnac-type loop configured to preserve an entanglement between the ion qubit and the photon during the first wavelength conversion using a polarization matching process; and a second photonic-wavelength conversion stage including: a second stage laser loop configured to perform a second wavelength conversion of the photon; and a second stage Sagnac-type loop configured to preserve an entanglement between the ion qubit and the photon during the second wavelength conversion using the polarization matching process.

Clause 2. The quantum computing system in accordance with clause 1, wherein the photon is a 493 nm barium photon.

Clause 3. The quantum computing system in accordance with any preceding clauses, wherein an output of the first photonic-wavelength conversion stage is obtained from an output of the first stage Sagnac-type loop and comprises an 825 nm photon.

Clause 4. The quantum computing system in accordance with any preceding clauses, wherein an output of the second photonic-wavelength conversion stage is obtained from an output of the second stage Sagnac-type loop and comprises a 1554 nm photon.

Clause 5. The quantum computing system in accordance with any preceding clauses, wherein the first stage laser loop comprises a 1228 nm laser, and wherein the second stage laser loop comprises a 1762 nm laser.

Clause 6. The quantum computing system in accordance with any preceding clauses, wherein the first stage laser loop and the first stage Sagnac-type loop share a first non-linear waveguide in which the first wavelength conversion is performed, and the second stage laser loop and the second stage Sagnac-type loop share a second non-linear waveguide in which the second wavelength conversion is performed.

Clause 7. The quantum computing system in accordance with any preceding clauses, wherein the first stage laser loop comprises a first stage laser polarizing beam splitter (PBS) and a first laser configured to emit a first laser beam onto the first stage laser PBS, wherein the second stage laser loop comprises a second stage laser PBS and a second laser configured to emit a second laser beam onto the second stage laser PBS, and wherein the polarization matching process comprises matching orthogonal polarizations of the first laser beam to orthogonal polarizations of the photon in the first non-linear waveguide, and matching orthogonal polarizations of the second laser beam to orthogonal polarizations of the photon in the second non-linear waveguide.

Clause 8. The quantum computing system in accordance with any preceding clauses, wherein at least one of the first non-linear waveguide and the second non-linear waveguide comprises a periodically poled lithium niobate waveguide.

Clause 9. The quantum computing system in accordance with any preceding clauses, wherein the first Sagnac-type loop comprises a first stage photon polarizing beam splitter (PBS), the first stage laser loop comprises a first stage laser PBS, the second Sagnac-type loop comprises a second stage photon PBS, and the second stage laser loop comprises a second stage laser PBS.

Clause 10. The quantum computing system in accordance with any preceding clauses, wherein the first stage Sagnac-type loop and the second stage Sagnac-type loop are further configured to tune two orthogonal polarizations of the photon obtained using respective polarized beam splitters.

Clause 11. A method for converting a photon wavelength, comprising: configuring a first stage laser loop in a first photonic-wavelength conversion stage to perform a first wavelength conversion of a photon emitted from an ion qubit; configuring a first stage Sagnac-type loop in the first photonic-wavelength conversion stage to preserve an entanglement between the ion qubit and the photon during the first wavelength conversion using a polarization matching process; configuring a second stage laser loop in a second photonic-wavelength conversion stage to perform a second wavelength conversion of the photon; and configuring the second stage Sagnac-type loop in the second photonic-wavelength conversion stage to preserve an entanglement between the ion qubit and the photon during the second wavelength conversion using the polarization matching process.

Clause 12. The method in accordance with clause 11, wherein the photon is a 493 nm barium photon.

Clause 13. The method in accordance with any preceding clauses, wherein an output of the first photonic-wavelength conversion stage is obtained from an output of the first stage Sagnac-type loop and comprises an 825 nm photon.

Clause 14. The method in accordance with any preceding clauses, wherein an output of the second photonic-wavelength conversion stage is obtained from an output of the second stage Sagnac-type loop and comprises a 1554 nm photon.

Clause 15. The method in accordance with any preceding clauses, wherein the first stage laser loop comprises a 1228 nm laser, and wherein the second stage laser loop comprises a 1762 nm laser.

Clause 16. The method in accordance with any preceding clauses, further comprising configuring the first stage laser loop and the first stage Sagnac-type loop to share a first non-linear waveguide in which the first wavelength conversion is performed, and configuring the second stage laser loop and the second stage Sagnac-type loop to share a second non-linear waveguide in which the second wavelength conversion is performed.

Clause 17. The method in accordance with any preceding clauses, wherein the first stage laser loop comprises a first stage laser polarizing beam splitter (PBS) and a first laser configured to emit a first laser beam onto the first stage laser PBS, wherein the second stage laser loop comprises a second stage laser PBS and a second laser configured to emit a second laser beam onto the second stage laser PBS, and wherein the polarization matching process comprises matching orthogonal polarizations of the first laser beam to orthogonal polarizations of the photon in the first non-linear waveguide, and matching orthogonal polarizations of the second laser beam to orthogonal polarizations of the photon in the second non-linear waveguide.

Clause 18. The method in accordance with any preceding clauses, further comprising using a wavelength for a laser of the first stage laser loop that is at least double an input wavelength of the photon, and using a wavelength for a laser of the second stage laser loop that is at least double a wavelength of a photon output from the second Sagnac-type loop.

Clause 19. The method in accordance with any preceding clauses, further comprising: configuring the first Sagnac-type loop to comprise a first stage photon polarizing beam splitter (PBS) operating as an originating point and a termination point for the first Sagnac-type loop; configuring the first stage laser loop to comprise a first stage laser PBS operating as an originating point and a termination point for the first stage laser loop; configuring the second Sagnac-type loop to comprise a second stage PBS operating as an originating point and a termination point for the second Sagnac-type loop; and configuring the second stage laser loop to comprise a second stage laser PBS operating as an originating point and a termination point for the second stage laser loop.

Clause 20. The method in accordance with any preceding clauses, further comprising configuring the first stage Sagnac-type loop and the second stage Sagnac-type loop to tune two orthogonal polarizations of the photon obtained using respective polarized beam splitters.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum computing system, comprising:
a first photonic-wavelength conversion stage including:
a first stage laser loop configured to perform a first wavelength conversion of a photon emitted from an ion qubit; and
a first stage Sagnac-type loop configured to preserve an entanglement between the ion qubit and the photon during the first wavelength conversion using a polarization matching process; and
a second photonic-wavelength conversion stage including:
a second stage laser loop configured to perform a second wavelength conversion of the photon; and
a second stage Sagnac-type loop configured to preserve an entanglement between the ion qubit and the photon during the second wavelength conversion using the polarization matching process.

2. The quantum computing system in accordance with claim 1, wherein the photon is a 493 nm barium photon.

3. The quantum computing system in accordance with claim 1, wherein an output of the first photonic-wavelength conversion stage is obtained from an output of the first stage Sagnac-type loop and comprises an 825 nm photon.

4. The quantum computing system in accordance with claim 1, wherein an output of the second photonic-wavelength conversion stage is obtained from an output of the second stage Sagnac-type loop and comprises a 1554 nm photon.

5. The quantum computing system in accordance with claim 1, wherein the first stage laser loop comprises a 1228 nm laser, and wherein the second stage laser loop comprises a 1762 nm laser.

6. The quantum computing system in accordance with claim 1, wherein the first stage laser loop and the first stage Sagnac-type loop share a first non-linear waveguide in which the first wavelength conversion is performed, and the second stage laser loop and the second stage Sagnac-type loop share a second non-linear waveguide in which the second wavelength conversion is performed.

7. The quantum computing system in accordance with claim 6,
wherein the first stage laser loop comprises a first stage laser polarizing beam splitter (PBS) and a first laser configured to emit a first laser beam onto the first stage laser PBS,
wherein the second stage laser loop comprises a second stage laser PBS and a second laser configured to emit a second laser beam onto the second stage laser PBS, and
wherein the polarization matching process comprises matching orthogonal polarizations of the first laser beam to orthogonal polarizations of the photon in the first non-linear waveguide, and matching orthogonal polarizations of the second laser beam to orthogonal polarizations of the photon in the second non-linear waveguide.

8. The quantum computing system in accordance with claim 6, wherein at least one of the first non-linear waveguide and the second non-linear waveguide comprises a periodically poled lithium niobate waveguide.

9. The quantum computing system in accordance with claim 1, wherein the first Sagnac-type loop comprises a first stage photon polarizing beam splitter (PBS), the first stage laser loop comprises a first stage laser PBS, the second Sagnac-type loop comprises a second stage photon PBS, and the second stage laser loop comprises a second stage laser PBS.

10. The quantum computing system in accordance with claim 1, wherein the first stage Sagnac-type loop and the second stage Sagnac-type loop are further configured to tune two orthogonal polarizations of the photon obtained using respective polarized beam splitters.

11. A method for converting a photon wavelength, comprising:
configuring a first stage laser loop in a first photonic-wavelength conversion stage to perform a first wavelength conversion of a photon emitted from an ion qubit;
configuring a first stage Sagnac-type loop in the first photonic-wavelength conversion stage to preserve an entanglement between the ion qubit and the photon during the first wavelength conversion using a polarization matching process;
configuring a second stage laser loop in a second photonic-wavelength conversion stage to perform a second wavelength conversion of the photon; and
configuring the second stage Sagnac-type loop in the second photonic-wavelength conversion stage to preserve an entanglement between the ion qubit and the photon during the second wavelength conversion using the polarization matching process.

12. The method in accordance with claim 11, wherein the photon is a 493 nm barium photon.

13. The method in accordance with claim 11, wherein an output of the first photonic-wavelength conversion stage is obtained from an output of the first stage Sagnac-type loop and comprises an 825 nm photon.

14. The method in accordance with claim 11, wherein an output of the second photonic-wavelength conversion stage is obtained from an output of the second stage Sagnac-type loop and comprises a 1554 nm photon.

15. The method in accordance with claim 11, wherein the first stage laser loop comprises a 1228 nm laser, and wherein the second stage laser loop comprises a 1762 nm laser.

16. The method in accordance with claim 11, further comprising configuring the first stage laser loop and the first stage Sagnac-type loop to share a first non-linear waveguide in which the first wavelength conversion is performed, and configuring the second stage laser loop and the second stage Sagnac-type loop to share a second non-linear waveguide in which the second wavelength conversion is performed.

17. The method in accordance with claim 16,
wherein the first stage laser loop comprises a first stage laser polarizing beam splitter (PBS) and a first laser configured to emit a first laser beam onto the first stage laser PBS,
wherein the second stage laser loop comprises a second stage laser PBS and a second laser configured to emit a second laser beam onto the second stage laser PBS, and
wherein the polarization matching process comprises matching orthogonal polarizations of the first laser beam to orthogonal polarizations of the photon in the first non-linear waveguide, and matching orthogonal polarizations of the second laser beam to orthogonal polarizations of the photon in the second non-linear waveguide.

18. The method in accordance with claim 16, further comprising using a wavelength for a laser of the first stage laser loop that is at least double an input wavelength of the photon, and using a wavelength for a laser of the second stage laser loop that is at least double a wavelength of a photon output from the second Sagnac-type loop.

19. The method in accordance with claim 11, further comprising:
configuring the first Sagnac-type loop to comprise a first stage photon polarizing beam splitter (PBS) operating as an originating point and a termination point for the first Sagnac-type loop;
configuring the first stage laser loop to comprise a first stage laser PBS operating as an originating point and a termination point for the first stage laser loop;
configuring the second Sagnac-type loop to comprise a second stage PBS operating as an originating point and a termination point for the second Sagnac-type loop; and
configuring the second stage laser loop to comprise a second stage laser PBS operating as an originating point and a termination point for the second stage laser loop.

20. The method in accordance with claim 11, further comprising configuring the first stage Sagnac-type loop and the second stage Sagnac-type loop to tune two orthogonal polarizations of the photon obtained using respective polarized beam splitters.
